(19) United States
(12) Patent Application Publication
(10) Pub. No.: US 2022/0021814 A1
(43) Pub. Date: Jan. 20, 2022

(54) METHODS TO SUPPORT TOUCHLESS FINGERPRINTING

(71) Applicant: SCIOMETRICS, LLC, Chantilly, VA (US)

(72) Inventors: Mark A. WALCH, Fairfax Station, VA (US); Daniel Thomas GANTZ, Arlington, VA (US); Richard SMITH, Hemdon, VA (US)

(21) Appl. No.: 17/377,271

(22) Filed: Jul. 15, 2021

Related U.S. Application Data
(60) Provisional application No. 63/052,262, filed on Jul. 15, 2020.

(51) Int. Cl. H04N 5/232; G06K 9/00; G06T 5/00

(52) U.S. Cl. CPC H04N 5/232127; H04N 5/23219; G06T 5/002; G06K 9/0008; G06K 9/00912; G06K 9/00013

(57) ABSTRACT

A method comprising using at least one hardware processor to: control a camera to begin at a prescribed starting position and move incrementally to capture a series of images of at least one fingerprint; once the images are captured, evaluating the captured images for best focus using an algorithm designed expressly for fingerprint ridge structure, wherein the focus in each frame can be determined by taking the average per pixel convolution value of a Laplace filter over a small region of the full resolution image and wherein the Laplace filter comprises: capturing an image at an initial focus distance, convolving the captured image with Laplacian of Gaussian kernel, assigning a score to the filtered image reflecting the amount to fine edge resolution, and dynamically updating the focus until an optimal distance is found.

### CROSS-REFERENCE TO RELATED APPLICATIONS

This application claims priority to U.S. Provisional Patent App. No. 63/052,262, filed on Jul. 15, 2020, which is hereby incorporated herein by reference as if set forth in full.

### BACKGROUND

### Field of the Inventions

Systems and methods for mobile fingerprinting are described herein, and more particular systems and methods that improve capture, resolution, matching and calibrating for touchless fingerprinting are described herein.

### Description of Related Art

Fingerprints are truly the “human barcode” and among the best measures of human identity available. Conventional fingerprint sensors require a person to touch the device platen or sensor. Disadvantages to this mode of acquisition include the time required to collect (particularly rolled) prints as well as hygiene concerns. Recently, technologies have been developed to use smartphones as fingerprinting devices. Since capturing fingerprints with the camera on a phone does not require physical contact, this method of collection has been labeled “touchless fingerprinting”.

Touchless fingerprinting can be performed by the rear smartphone camera with no additional hardware. A 12 megapixel camera can produce high resolution images that capture sufficient friction ridge detail to support fingerprint matching.

A typical strategy for touchless fingerprinting is to capture 10 fingers in three pictures: two “slaps” (four fingers each) plus two thumbs held together. Once captured, the images are processed into high-contrast prints; features are extracted from these prints and placed into record format suitable for automated inquiries—such as a standard image format (.png, jpg, etc) or as specialized biometric format (EFTS, EBTS). Matching can either be performed on the mobile device or the fingerprint images can be set to a remote server—or cloud location—for matching. In those cases where fingerprint matching is not performed on the device, the fingerprint images are typically sent to an Automated Fingerprint Identification System (AFIS) which is typically operated by a Federal, State or Local Government entity.

Two types of fingerprints can be submitted for AFIS queries:

(1) livescan prints, which are fingerprints obtained directly from an individual by a scanner, and

(2) latent prints, which are prints collected from the oils and amino acids fingers deposit on surfaces.

In terms of submitting livescan prints to an AFIS, standards have been developed based on certification of scanners. In the United States, the most significant standard is the FBI's Appendix F and PIV (personal identity verification) criteria for certifying scanners. Since latent prints are acquired after the prints have already been deposited, there are no scanner standards for capturing them if image resolution meets the required value which is usually 1,000 pixels per inch. The concepts of livescan and latent prints are both relevant to touchless fingerprinting.

### SUMMARY

Accordingly, systems, methods, and non-transitory computer-readable media are disclosed to perform mobile touchless fingerprinting.

In an embodiment, a method comprising using at least one hardware processor to: control a camera to begin at a prescribed starting position and move incrementally to capture a series of images of at least one fingerprint; once the images are captured, evaluating the captured images for best focus using an algorithm designed expressly for fingerprint ridge structure, wherein the focus in each frame can be determined by taking the average per pixel convolution value of a Laplace filter over a small region of the full resolution image and wherein the Laplace filter comprises: capturing an image at an initial focus distance, convolving the captured image with Laplacian of Gaussian kernel, assigning a score to the filtered image reflecting the amount to fine edge resolution, and dynamically updating the focus until an optimal distance is found.

The method may be embodied in executable software modules of a processor-based system, such as a server, and/or in executable instructions stored in a non-transitory computer-readable medium.

### BRIEF DESCRIPTION OF THE DRAWINGS

The details of the present invention, both as to its structure and operation, may be gleaned in part by study of the accompanying drawings, in which like reference numerals refer to like parts, and in which:

FIG. 1 illustrates an example infrastructure, in which one or more of the processes described herein, may be implemented, according to an embodiment;

FIG. 2 illustrates an example processing system, by which one or more of the processes described herein, may be executed, according to an embodiment;

FIGS. 3A and 3B illustrate examples of touchless fingerprinting, according to an embodiment;

FIG. 4 illustrates a sample calibration session, according to one embodiment;

FIGS. 5a and 5B illustrate the process of taking a burst of multiple images at multiple distances from the camera, according to an embodiment;

FIG. 6 illustrates a Laplace-based method for finger focus detection, according to one embodiment;

FIG. 7 shows an example user interface for automated fingerprint capture, according to one embodiment;

FIG. 8 illustrates a series of images comparing a set of fingers and photographs taken both with the torch on and the torch off, according to one embodiment;

FIG. 9 illustrates an overview of the RSM matching process when applied to latent fingerprint matching, according to one embodiment;

FIG. 10 illustrates a scale image and enlargement of several small finger fragments from the same finger matched using the RSM method, according to one embodiment;

FIGS. 11A and 11B illustrate matching fingerprints using a minutiae-based fingerprint matcher, according to one embodiment;

FIG. 12 illustrates the difference in the amount of ridge structure that can be captured using a native camera app as opposed to using an app designed expressly to capture fingerprints, according to one embodiment;

FIG. 13 illustrates the “afterburner” process applied to latent prints. The afterburner process entails processing contactless fingerprints from a suspect as “latents”, according to one embodiment;

FIG. 14 illustrates an image of a finger mapped to the correct reference using the non-linear mesh that is intrinsic to the RSM-matching method, according to one embodiment; and

FIG. 15 illustrates an example of a set of ten fingerprints rendered by the True Form method, according to an embodiment.

### DETAILED DESCRIPTION

After reading this description, it will become apparent to one skilled in the art how to implement the invention in various alternative embodiments and alternative applications. However, although various embodiments of the present invention will be described herein, it is understood that these embodiments are presented by way of example and illustration only, and not limitation. As such, this detailed description of various embodiments should not be construed to limit the scope or breadth of the present invention as set forth in the appended claims.

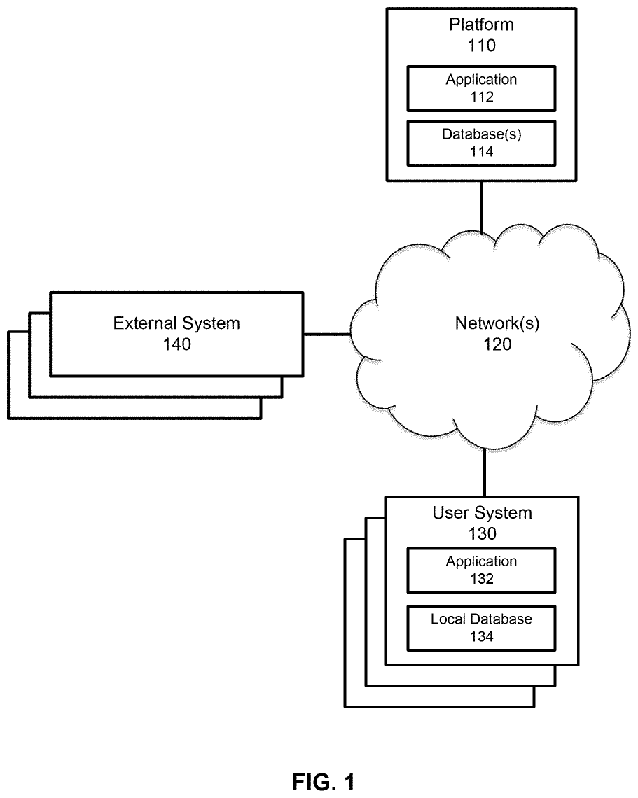

FIG. 1 illustrates an example infrastructure in which one or more of the disclosed processes may be implemented, according to an embodiment. The infrastructure may comprise a platform 110 (e.g., one or more servers) which hosts and/or executes one or more of the various functions, processes, methods, and/or software modules described herein. Platform 110 may comprise dedicated servers, or may instead comprise cloud instances, which utilize shared resources of one or more servers. These servers or cloud instances may be collocated and/or geographically distributed. Platform 110 may also comprise or be communicatively connected to a server application 112 and/or one or more databases 114. In addition, platform 110 may be communicatively connected to one or more user systems 130 via one or more networks 120. Platform 110 may also be communicatively connected to one or more external systems 140 (e.g., other platforms, websites, etc.) via one or more networks 120.

Network(s) 120 may comprise the Internet, and platform 110 may communicate with user system(s) 130 through the Internet using standard transmission protocols, such as HyperText Transfer Protocol (HTTP), HTTP Secure (HTTPS), File Transfer Protocol (FTP), FTP Secure (FTPS), Secure Shell FTP (SFTP), and the like, as well as proprietary protocols. While platform 110 is illustrated as being connected to various systems through a single set of network(s) 120, it should be understood that platform 110 may be connected to the various systems via different sets of one or more networks. For example, platform 110 may be connected to a subset of user systems 130 and/or external systems 140 via the Internet, but may be connected to one or more other user systems 130 and/or external systems 140 via an intranet. Furthermore, while only a few user systems 130 and external systems 140, one server application 112, and one set of database(s) 114 are illustrated, it should be understood that the infrastructure may comprise any number of user systems, external systems, server applications, and databases.

User system(s) 130 may comprise any type or types of computing devices capable of wired and/or wireless communication, including without limitation, desktop computers, laptop computers, tablet computers, smart phones or other mobile phones, servers, game consoles, televisions, set-top boxes, electronic kiosks, point-of-sale terminals, Automated Teller Machines, and/or the like.

Platform 110 may comprise web servers which host one or more websites and/or web services. In embodiments in which a website is provided, the website may comprise a graphical user interface, including, for example, one or more screens (e.g., webpages) generated in HyperText Markup Language (HTML) or other language. Platform 110 transmits or serves one or more screens of the graphical user interface in response to requests from user system(s) 130. In some embodiments, these screens may be served in the form of a wizard, in which case two or more screens may be served in a sequential manner, and one or more of the sequential screens may depend on an interaction of the user or user system 130 with one or more preceding screens. The requests to platform 110 and the responses from platform 110, including the screens of the graphical user interface, may both be communicated through network(s) 120, which may include the Internet, using standard communication protocols (e.g., HTTP, HTTPS, etc.). These screens (e.g., webpages) may comprise a combination of content and elements, such as text, images, videos, animations, references (e.g., hyperlinks), frames, inputs (e.g., textboxes, text areas, checkboxes, radio buttons, drop-down menus, buttons, forms, etc.), scripts (e.g., JavaScript), and the like, including elements comprising or derived from data stored in one or more databases (e.g., database(s) 114) that are locally and/or remotely accessible to platform 110. Platform 110 may also respond to other requests from user system(s) 130.

Platform 110 may further comprise, be communicatively coupled with, or otherwise have access to one or more database(s) 114. For example, platform 110 may comprise one or more database servers which manage one or more databases 114. A user system 130 or server application 112 executing on platform 110 may submit data (e.g., user data, form data, etc.) to be stored in database(s) 114, and/or request access to data stored in database(s) 114. Any suitable database may be utilized, including without limitation MySQL™, Oracle™ IBM™, Microsoft SQL™, Access™, PostgreSQL™, and the like, including cloud-based databases and proprietary databases. Data may be sent to platform 110, for instance, using the well-known POST request supported by HTTP, via FTP, and/or the like. This data, as well as other requests, may be handled, for example, by server-side web technology, such as a servlet or other software module (e.g., comprised in server application 112), executed by platform 110.

In embodiments in which a web service is provided, platform 110 may receive requests from external system(s) 140, and provide responses in eXtensible Markup Language (XML), JavaScript Object Notation (JSON), and/or any other suitable or desired format. In such embodiments, platform 110 may provide an application programming interface (API) which defines the manner in which user system(s) 130 and/or external system(s) 140 may interact with the web service. Thus, user system(s) 130 and/or external system(s) 140 (which may themselves be servers), can define their own user interfaces, and rely on the web service to implement or otherwise provide the backend processes, methods, functionality, storage, and/or the like, described herein. For example, in such an embodiment, a client application 132, executing on one or more user system(s) 130 and potentially using a local database 134, may interact with a server application 112 executing on platform 110 to execute one or more or a portion of one or more of the various functions, processes, methods, and/or software modules described herein. In an embodiment, client application 132 may utilize a local database 134 for storing data locally on user system 130. Client application 132 may be “thin,” in which case processing is primarily carried out server-side by server application 112 on platform 110. A basic example of a thin client application 132 is a browser application, which simply requests, receives, and renders webpages at user system(s) 130, while server application 112 on platform 110 is responsible for generating the webpages and managing database functions. Alternatively, the client application may be “thick,” in which case processing is primarily carried out client-side by user system(s) 130. It should be understood that client application 132 may perform an amount of processing, relative to server application 112 on platform 110, at any point along this spectrum between “thin” and “thick,” depending on the design goals of the particular implementation. In any case, the application described herein, which may wholly reside on either platform 110 (e.g., in which case server application 112 performs all processing) or user system(s) 130 (e.g., in which case client application 132 performs all processing) or be distributed between platform 110 and user system(s) 130 (e.g., in which case server application 112 and client application 132 both perform processing), can comprise one or more executable software modules comprising instructions that implement one or more of the processes, methods, or functions of the application described herein.

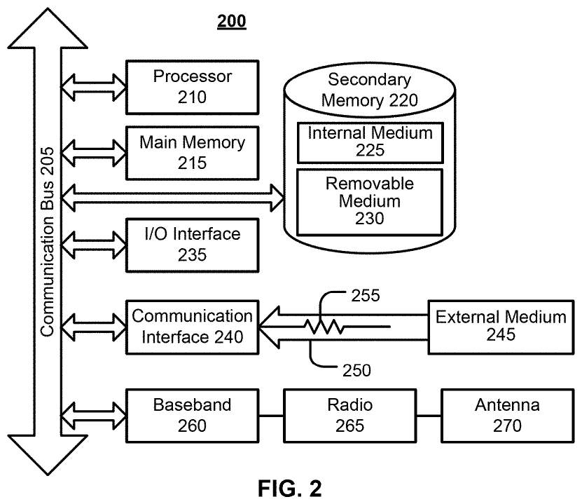

FIG. 2 is a block diagram illustrating an example wired or wireless system 200 that may be used in connection with various embodiments described herein. For example, system 200 may be used as or in conjunction with one or more of the functions, processes, or methods (e.g., to store and/or execute the application or one or more software modules of the application) described herein, and may represent components of platform 110, user system(s) 130, external system(s) 140, and/or other processing devices described herein. System 200 can be a server or any conventional personal computer, or any other processor-enabled device that is capable of wired or wireless data communication. Other computer systems and/or architectures may be also used, as will be clear to those skilled in the art.

System 200 preferably includes one or more processors 210. Processor(s) 210 may comprise a central processing unit (CPU). Additional processors may be provided, such as a graphics processing unit (GPU), an auxiliary processor to manage input/output, an auxiliary processor to perform floating-point mathematical operations, a special-purpose microprocessor having an architecture suitable for fast execution of signal-processing algorithms (e.g., digital-signal processor), a slave processor subordinate to the main processing system (e.g., back-end processor), an additional microprocessor or controller for dual or multiple processor systems, and/or a coprocessor. Such auxiliary processors may be discrete processors or may be integrated with processor 210. Examples of processors which may be used with system 200 include, without limitation, the Pentium® processor, Core i7® processor, and Xeon® processor, all of which are available from Intel Corporation of Santa Clara, Calif.

Processor 210 is preferably connected to a communication bus 205. Communication bus 205 may include a data channel for facilitating information transfer between storage and other peripheral components of system 200. Furthermore, communication bus 205 may provide a set of signals used for communication with processor 210, including a data bus, address bus, and/or control bus (not shown). Communication bus 205 may comprise any standard or non-standard bus architecture such as, for example, bus architectures compliant with industry standard architecture (ISA), extended industry standard architecture (EISA), Micro Channel Architecture (MCA), peripheral component interconnect (PCI) local bus, standards promulgated by the Institute of Electrical and Electronics Engineers (IEEE) including IEEE 488 general-purpose interface bus (GPM), IEEE 696/S-100, and/or the like.

System 200 preferably includes a main memory 215 and may also include a secondary memory 220. Main memory 215 provides storage of instructions and data for programs executing on processor 210, such as one or more of the functions and/or modules discussed herein. It should be understood that programs stored in the memory and executed by processor 210 may be written and/or compiled according to any suitable language, including without limitation C/C++, Java, JavaScript, Perl, Visual Basic, .NET, and the like. Main memory 215 is typically semiconductor-based memory such as dynamic random access memory (DRAM) and/or static random access memory (SRAM). Other semiconductor-based memory types include, for example, synchronous dynamic random access memory (SDRAM), Rambus dynamic random access memory (RDRAM), ferroelectric random access memory (FRAM), and the like, including read only memory (ROM).

Secondary memory 220 may optionally include an internal medium 225 and/or a removable medium 230. Removable medium 230 is read from and/or written to in any well-known manner. Removable storage medium 230 may be, for example, a magnetic tape drive, a compact disc (CD) drive, a digital versatile disc (DVD) drive, other optical drive, a flash memory drive, and/or the like.

Secondary memory 220 is a non-transitory computer-readable medium having computer-executable code (e.g., disclosed software modules) and/or other data stored thereon. The computer software or data stored on secondary memory 220 is read into main memory 215 for execution by processor 210.

In alternative embodiments, secondary memory 220 may include other similar means for allowing computer programs or other data or instructions to be loaded into system 200. Such means may include, for example, a communication interface 240, which allows software and data to be transferred from external storage medium 245 to system 200. Examples of external storage medium 245 may include an external hard disk drive, an external optical drive, an external magneto-optical drive, and/or the like. Other examples of secondary memory 220 may include semiconductor-based memory, such as programmable read-only memory (PROM), erasable programmable read-only memory (EPROM), electrically erasable read-only memory (EEPROM), and flash memory (block-oriented memory similar to EEPROM).

As mentioned above, system 200 may include a communication interface 240. Communication interface 240 allows software and data to be transferred between system 200 and external devices (e.g. printers), networks, or other information sources. For example, computer software or executable code may be transferred to system 200 from a network server (e.g., platform 110) via communication interface 240. Examples of communication interface 240 include a built-in network adapter, network interface card (NIC), Personal Computer Memory Card International Association (PCMCIA) network card, card bus network adapter, wireless network adapter, Universal Serial Bus (USB) network adapter, modem, a wireless data card, a communications port, an infrared interface, an IEEE 1394 fire-wire, and any other device capable of interfacing system 200 with a network (e.g., network(s) 120) or another computing device. Communication interface 240 preferably implements industry-promulgated protocol standards, such as Ethernet IEEE 802 standards, Fiber Channel, digital subscriber line (DSL), asynchronous digital subscriber line (ADSL), frame relay, asynchronous transfer mode (ATM), integrated digital services network (ISDN), personal communications services (PCS), transmission control protocol/Internet protocol (TCP/IP), serial line Internet protocol/point to point protocol (SLIP/PPP), and so on, but may also implement customized or non-standard interface protocols as well.

Software and data transferred via communication interface 240 are generally in the form of electrical communication signals 255. These signals 255 may be provided to communication interface 240 via a communication channel 250. In an embodiment, communication channel 250 may be a wired or wireless network (e.g., network(s) 120), or any variety of other communication links. Communication channel 250 carries signals 255 and can be implemented using a variety of wired or wireless communication means including wire or cable, fiber optics, conventional phone line, cellular phone link, wireless data communication link, radio frequency (“RF”) link, or infrared link, just to name a few.

Computer-executable code (e.g., computer programs, such as the disclosed application, or software modules) is stored in main memory 215 and/or secondary memory 220. Computer programs can also be received via communication interface 240 and stored in main memory 215 and/or secondary memory 220. Such computer programs, when executed, enable system 200 to perform the various functions of the disclosed embodiments as described elsewhere herein.

In this description, the term “computer-readable medium” is used to refer to any non-transitory computer-readable storage media used to provide computer-executable code and/or other data to or within system 200. Examples of such media include main memory 215, secondary memory 220 (including internal memory 225, removable medium 230, and external storage medium 245), and any peripheral device communicatively coupled with communication interface 240 (including a network information server or other network device). These non-transitory computer-readable media are means for providing executable code, programming instructions, software, and/or other data to system 200.

In an embodiment that is implemented using software, the software may be stored on a computer-readable medium and loaded into system 200 by way of removable medium 230, I/O interface 235, or communication interface 240. In such an embodiment, the software is loaded into system 200 in the form of electrical communication signals 255. The software, when executed by processor 210, preferably causes processor 210 to perform one or more of the processes and functions described elsewhere herein.

In an embodiment, I/O interface 235 provides an interface between one or more components of system 200 and one or more input and/or output devices. Example input devices include, without limitation, sensors, keyboards, touch screens or other touch-sensitive devices, cameras, biometric sensing devices, computer mice, trackballs, pen-based pointing devices, and/or the like. Examples of output devices include, without limitation, other processing devices, cathode ray tubes (CRTs), plasma displays, light-emitting diode (LED) displays, liquid crystal displays (LCDs), printers, vacuum fluorescent displays (VFDs), surface-conduction electron-emitter displays (SEDs), field emission displays (FEDs), and/or the like. In some cases, an input and output device may be combined, such as in the case of a touch panel display (e.g., in a smartphone, tablet, or other mobile device).

System 200 may also include optional wireless communication components that facilitate wireless communication over a voice network and/or a data network (e.g., in the case of user system 130). The wireless communication components comprise an antenna system 270, a radio system 265, and a baseband system 260. In system 200, radio frequency (RF) signals are transmitted and received over the air by antenna system 270 under the management of radio system 265.

In an embodiment, antenna system 270 may comprise one or more antennae and one or more multiplexors (not shown) that perform a switching function to provide antenna system 270 with transmit and receive signal paths. In the receive path, received RF signals can be coupled from a multiplexor to a low noise amplifier (not shown) that amplifies the received RF signal and sends the amplified signal to radio system 265.

In an alternative embodiment, radio system 265 may comprise one or more radios that are configured to communicate over various frequencies. In an embodiment, radio system 265 may combine a demodulator (not shown) and modulator (not shown) in one integrated circuit (IC). The demodulator and modulator can also be separate components. In the incoming path, the demodulator strips away the RF carrier signal leaving a baseband receive audio signal, which is sent from radio system 265 to baseband system 260.

If the received signal contains audio information, then baseband system 260 decodes the signal and converts it to an analog signal. Then the signal is amplified and sent to a speaker. Baseband system 260 also receives analog audio signals from a microphone. These analog audio signals are converted to digital signals and encoded by baseband system 260. Baseband system 260 also encodes the digital signals for transmission and generates a baseband transmit audio signal that is routed to the modulator portion of radio system 265. The modulator mixes the baseband transmit audio signal with an RF carrier signal, generating an RF transmit signal that is routed to antenna system 270 and may pass through a power amplifier (not shown). The power amplifier amplifies the RF transmit signal and routes it to antenna system 270, where the signal is switched to the antenna port for transmission.

Baseband system 260 is also communicatively coupled with processor(s) 210. Processor(s) 210 may have access to data storage areas 215 and 220. Processor(s) 210 are preferably configured to execute instructions (i.e., computer programs, such as the disclosed application, or software modules) that can be stored in main memory 215 or secondary memory 220. Computer programs can also be received from baseband processor 260 and stored in main memory 210 or in secondary memory 220, or executed upon receipt. Such computer programs, when executed, enable system 200 to perform the various functions of the disclosed embodiments.

Embodiments of processes for mobile touchless fingerprinting will now be described in detail. It should be understood that the described processes may be embodied in one or more software modules that are executed by one or more hardware processors (e.g., processor 210), for example, as the application discussed herein (e.g., server application 112, client application 132, and/or a distributed application comprising both server application 112 and client application 132), which may be executed wholly by processor(s) of platform 110, wholly by processor(s) of user system(s) 130, or may be distributed across platform 110 and user system(s) 130, such that some portions or modules of the application are executed by platform 110 and other portions or modules of the application are executed by user system(s) 130. The described processes may be implemented as instructions represented in source code, object code, and/or machine code. These instructions may be executed directly by hardware processor(s) 210, or alternatively, may be executed by a virtual machine operating between the object code and hardware processors 210. In addition, the disclosed application may be built upon or interfaced with one or more existing systems.

Alternatively, the described processes may be implemented as a hardware component (e.g., general-purpose processor, integrated circuit (IC), application-specific integrated circuit (ASIC), digital signal processor (DSP), field-programmable gate array (FPGA) or other programmable logic device, discrete gate or transistor logic, etc.), combination of hardware components, or combination of hardware and software components. To clearly illustrate the interchangeability of hardware and software, various illustrative components, blocks, modules, circuits, and steps are described herein generally in terms of their functionality. Whether such functionality is implemented as hardware or software depends upon the particular application and design constraints imposed on the overall system. Skilled persons can implement the described functionality in varying ways for each particular application, but such implementation decisions should not be interpreted as causing a departure from the scope of the invention. In addition, the grouping of functions within a component, block, module, circuit, or step is for ease of description. Specific functions or steps can be moved from one component, block, module, circuit, or step to another without departing from the invention.

Furthermore, while the processes, described herein, are illustrated with a certain arrangement and ordering of subprocesses, each process may be implemented with fewer, more, or different subprocesses and a different arrangement and/or ordering of subprocesses. In addition, it should be understood that any subprocess, which does not depend on the completion of another subprocess, may be executed before, after, or in parallel with that other independent subprocess, even if the subprocesses are described or illustrated in a particular order.

U.S. Pat. No. 9,684,815 (the '815 patent) entitled “Mobility empowered biometric appliance a tool for real-time verification of identity through fingerprints” provides an example of a touchless fingerprinting device. The ensuing discussion addresses various methods to improve performance of the implementation of touchless fingerprinting on such a device.

Images produced by a touchless device are fundamentally different from conventional scanned ink and livescan fingerprints. Touchless prints differ in both distortion characteristics and image sensor characteristics. New pathways for device certification are being developed for touchless fingerprinting, and these new touchless fingerprint images must be matchable to conventional fingerprints. Through the aforementioned funding from the FBI's Biometric Center for Excellence, NIST has been developing standards for certifying touchless scanning so images obtained in this manner can be submitted for matching against the FBI's databases. The proposed improvements to touchless fingerprinting described herein comprise a technology that can, e.g., be employed by the FBI to improve performance for matching touchless prints submitted against its legacy collections.

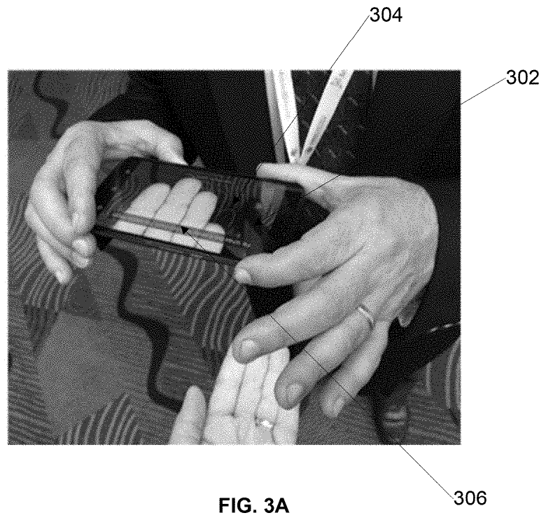

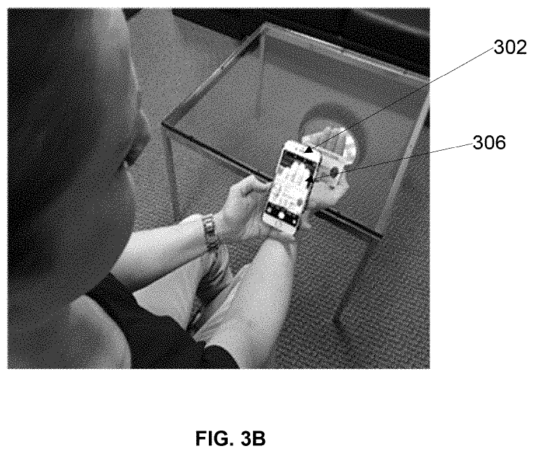

FIGS. 3A and B provide two examples of methods for performing mobile touchless fingerprinting: (1) Illustrated in FIG. 3A, illustrates that fingerprints can be captured in “administered” mode, where one person captures another person's prints; and (2) illustrated if FIG. 3B, where prints are captured in “selfie” mode, where a person captures their own prints.

As can be seen in FIG. 3A, the administrator uses a device 302 with a display 3404 and camera (not shown) to capture an image 306 of the users four fingers. In FIG. 3B, the user uses their own device 302 to capture and image of their fingers 306.

The '815 patent describes how a device 302 can be used for mobile touchless fingerprinting. The following disclosure provides additional techniques can help ensure such touchless fingerprinting produces images that are accurate and comparable to legacy contact fingerprints in terms of their ability to establish personal identity. Eight methods are described including:

(1) ACCURATE RESOLUTION ESTIMATE BY AUTOMATED SENSOR FOCAL PLANE CALIBRATION;

(2) BURST-IMAGING FOR GEOMETRIC FIDELITY OF TOUCHLESS FINGERPRINT RESOLUTION;

(3) METHOD FOR OBTAINING BEST FOCUS FOR INDIVIDUAL FINGERS;

(4) AUTOMATED INITIATION OF FINGERPRINT CAPTURE;

(5) AUTOMATED LIVENESS DETECTION;

(6) AFTERBURNER SUPPORT FOR LATENT FINGERPRINT MATCHING;

(7) ORTHOGONAL METHOD TO AS A NAKED FINGER MATCHING METHOD AND MEANS OF AUTOMATIC CALIBRATION; and

(8) TRUE FORM RENDERING.

Accurate Resolution Estimate by Automated Sensor Focal Plane Calibration

When capturing a biometric such as fingerprints using a mobile device's camera or cameras, a scale or resolution needs to be determined in order for an eventual downstream rendering of the biometric to be used successfully for matching purposes against an existing biometric matcher technology. The resolution of a 2D focal plane of a camera's captured image can be used to estimate such a scale for an object being captured that crosses that focal plane. In order to calculate this resolution, accurate measurements of the camera's sensor size, focal length, captured image size and focal distance are required. However, the reported values for these metrics via software, most ubiquitously in regard to the focal distance, from any given mobile camera device is, to date, inaccurate and cannot be directly used to calculate the desired resolution.

The magnitude and variance of the focal distance error, between what is reported by the camera and what is physically measured in a test environment, varies greatly not only between different mobile device makes and models, but also between devices of the same model. However, we have found that the reported focal distance is consistent for a single device instance across different captures focused on the same focal plane. Therefore, we were able to develop a calibration routine such that a ‘calibrated’ device would automatically correct for the inaccurate, reported camera metrics and produce an accurate resolution estimate for the focal plane of an image captured by the mobile camera.

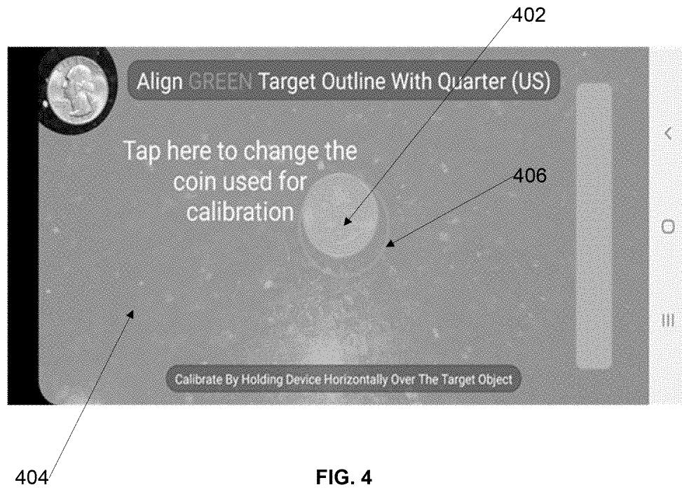

A user guided calibration routine, where the user needs to know little of the underlying calibration technique and only has to follow prompts that guide the process are described herein. The calibration routine takes a number, which is configurable, e.g., 15, of automatically captured, in focus images of a given target from a selected list, e.g., a US Quarter or a specially printed target of known dimensions, at different desired focal plane resolutions, analogous to a range of desired camera to target distances. FIG. 4 shows a sample calibration session based on a U.S. Quarter 402.

During the calibration process, the software, e.g., application 132, takes care of capturing the in focus image automatically, the user just has to move the device such that the on screen ‘expected target guide’ 406, for the given desired focal plane resolution, aligns roughly with the physical target 402 shown on the mobile device camera display 404.

Once the user makes the initial alignment, the software 132 automatically detects when the target 402 is in the neighborhood of what is expected, and an automatic capture routine is run to capture the target quickly in focus. The software 132 then detects the in focus, captured physical target 402 in the rendered image and automatically measures its dimensions.

Since the following are know: (1) the physical dimensions of the target object 402, e.g., in inches, (2) the measured dimensions of the target 402 at different, in focus image planes, e.g., in pixels, and (3) the reported (inaccurate) focal distances from the camera at the time of the image captures, a regression that maps the consistent yet inaccurate, reported focal distance to the resolution of the focal plane can be created, e.g., in pixels per inch. A ‘calibrated’ device such that a known good estimation of the resolution of an in focus, captured biometric from a mobile device's camera has now been created.

This process is repeated multiple times to construct an “Error Table” for the device that equates the nominal dimension reported by the camera against the known error for the camera at specific distance measurements. When the nominal dimension for a distance is adjusted by the values in the error table for a particular distance, the result is an accurate value for the actual distance between the camera and the subject. The ultimate result of calibration is using the true distance from the camera to the subject to calculate the image resolution, e.g., in pixels per inch (pp), for the captured fingerprint image.

Burst-Imaging for Geometric Fidelity of Touchless Fingerprint Resolution

A description of the multi-burst focus method for capturing the best picture from a series. Also include a discussion of independent finger focusing.

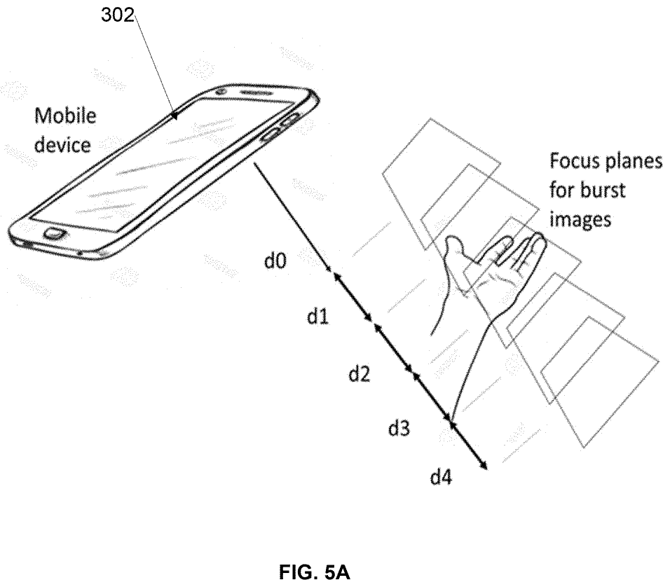

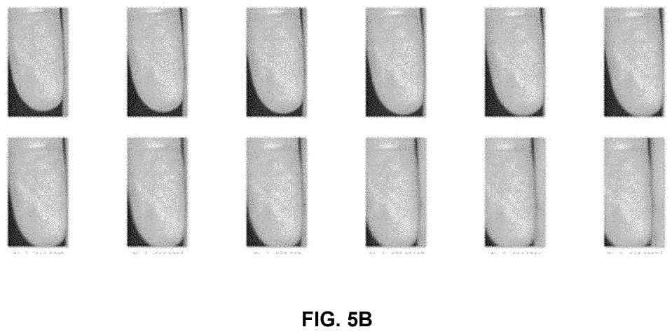

This process leverages a routine to produce an in-focus image for each finger being captured. The results from the routine are dependent on the characteristics and capabilities of the hardware camera and camera control software. FIGS. 5A and B illustrate the process of taking a burst of multiple images at multiple distances from the camera. The bursts start at a point close to the near focus of the lens and extend several inches from this point away from the camera. The purpose of the “burst zone” is to create an area where the hand can be placed to ensure an in-focus picture will be captured.

In FIG. 5A, the dimension d0 represents the distance from the camera (not shown) to the plane of the first image within the burst. Distances d1, d2, d3 and d4 represent additional bursts taken at incremental distances. The actual distance between images is determined by the depth-of-field of the camera at a particular distance. Images are captured at increments equal to the depth of field to ensure there is a zone between the beginning and end of the burst sequence where an in-focus version of the finger can be found. FIG. 5B shows changes in focus as images are captured at different focus planes.

Implementing a mobile fingerprinting capability without operator guidance requires adaptation of the mobile device 302 to capture images likely to contain friction ridge detail. Revealing ridges requires focus and image resolution work hand-in-hand to achieve a sharply focused image with an established resolution. Modern smartphones provide control access to the onboard camera to set focus distance through software, e.g., application 132.

Achieving touchless capture as herein described, requires control of focus and resolution by “image stacking”—that is, through software, the device 302 captures a series of images at slightly different distances, evaluating each photograph and selecting the one that is in best focus. Finding the best image in the image stack is based on evaluating every frame taken in a specified distance interval across a specified time frame.

Thus, the camera can begin a prescribed starting position and moves incrementally to capture a series of images. The increments are also configurable and based upon the depth of field of the camera at a certain f-value and focus distance. Once the images are captured, they can be evaluated for best focus using an algorithm designed expressly for fingerprint ridge structure. The focus in each frame can be determined by taking the average per pixel convolution value of a Laplace filter over a small region of the full resolution image that the target's skin encompasses.

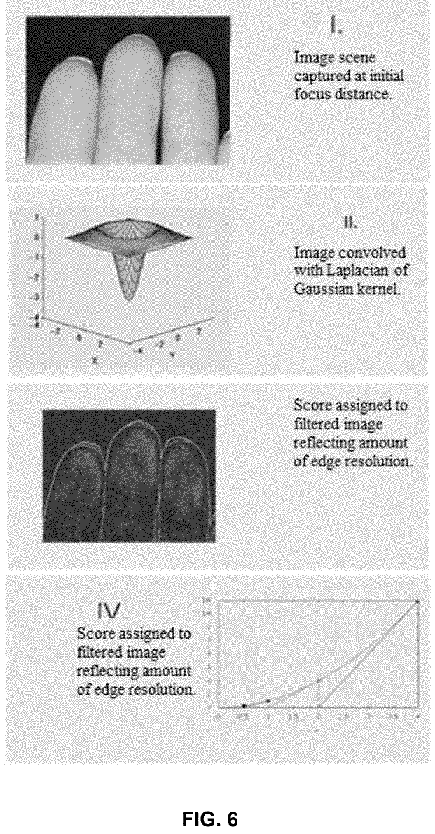

FIG. 6 describes the Laplace-based method for finger focus detection. First, in step I, an image of a user's fingers is captured. The size of the region comprising the fingers is adjusted based off the current focal distance reported by the camera to reduce the chance that background is included in target region, thus negatively impacting the averaged value. For larger focal distances, the viewed target is smaller in pixel measurements, so the region's size is reduced to better guarantee skin coverage within the entire region. Likewise, smaller focus distances have larger target regions.

Focus can be adjusted in real time or it can be applied as an analysis to a stack of images. In the real time implementation, after each frame's focus value is calculated, the camera's focus distance is adjusted in attempt to better the focus value upon the next frame's capture. The determination of which direction (closer or farther) to adjust the focus is based on the difference of the focus values of the last two frames in the following manner:

1) if the focus is getting worse, then reverse the direction of focus distance adjustment,

2) if the focus is getting better, maintain the direction of focus distance adjustment.

Initially the incremental step that the focus distance is adjusted is large (and can be configurable), but after each focus distance adjustment, the magnitude of the incremental step is slightly reduced. The adjustment of the incremental step continues until the incremental step is reduced to a configurable minimum value.

Since the “ideal” focus distance is constantly changing due to both the unsteady camera and the unsteady target, this method good for quickly adjusting the focus distance to the ballpark of where it should be to have the target in focus, and then minimally adjusted for the remainder of the stream to capture a frame of the moving target at a locally maximized focus value. The steps involved in automated focusing for fingerprints is resented in FIG. 5A.

Thus the Laplace based method comprises, in step I, an image is captured at an initial focus distance. Then in step II, the captured image is convolved with Laplacian of Gaussian kernel. In step III, scores are assigned to a filtered image reflecting the amount to fine edge resolution. In step IV, the focus is then dynamically updated until an optimal distance is found.

Once focus distance is established, it becomes the basis for calculating image resolution. The resolution of the best, full resolution image is derived from the focus distance, FD, recorded at the time the image was taken. The resolution of the image is equal to (W*FL)/(Sx*FD) where W is the width of the camera image, FL is the focus length of the camera and Sx is the physical sensor size, e.g., the width in this case, of the camera.

In the absence of the ability to control focus distance, the conventional solution has been to place an object of known dimension in the image. Such “target” based techniques can be used with older equipment where camera controls are not provided.

If focus evaluation is applied as a post image capture step, the same process is applied sequentially to each frame resulting in a frame-specific score. Once scores for all the images have been captured, the scoring can be compared to find the image with the best finger focus. The ability to capture multiple images permits a best focus to be established for individual fingers.

Method for Obtaining Best Focus for Individual Fingers

The pre-capture sequence described in the disclosure section entitled “BURST-IMAGING FOR GEOMETRIC FIDELITY OF TOUCHLESS FINGERPRINT RESOLUTION” establishes where the detected fingers are in the camera frame. This information is used to get a frame for each finger that maximizes the quality for that finger when a capture burst is taken across the calibrated camera to target zone. As the capture burst is being taken, each frame is evaluated for each detected finger as to the quality of the detected finger in the frame using the previously describe Laplace-based method. In the end, an image snippet is captured for each finger maximizing its quality metric individually. The result is a set of images where each image represents the best focus for a particular finger.

Automated Initiation of Fingerprint Capture

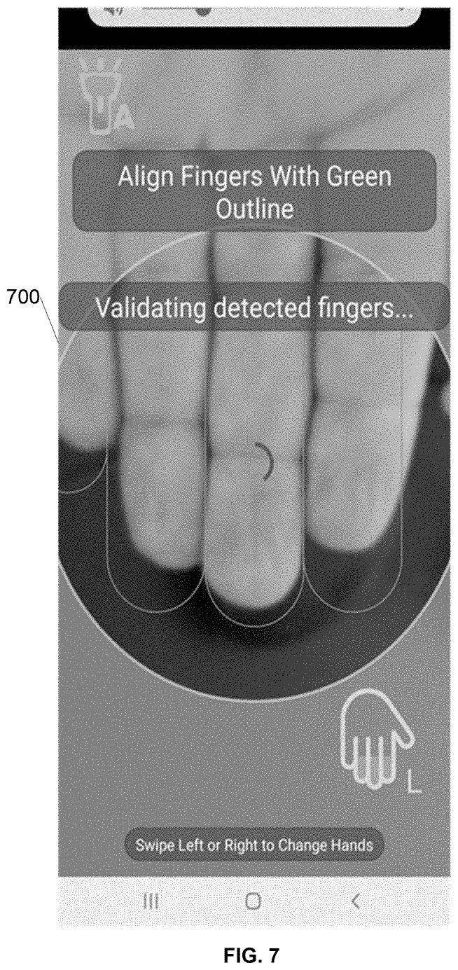

To improve usability, the sequence of capturing fingerprints can be automated to not require any user intervention. This is obtained using the previously described capture methods to detect the finger tips in real time during the pre-capture sequence when the user is placing their (or another person's) hand in front of the camera. The engine evaluates the validity of the detected fingers for a single frame and whether the detected fingers are consistent temporally across a sequence of detected fingers. The user is prompted to adjust the target appropriately if the detected fingers are considered invalid. Invalid conditions could be the fingers are placed outside the camera to target zone that the device is calibrated for, whether the wrong hand is being detected, etc. Once a valid sequence of detections is achieved, the actual capture sequence is automatically initiated. The same metrics are then run on the final capture to make sure that the detections in the final capture are also considered valid. FIG. 7 shows an example user interface 700 for automated fingerprint capture.

Automated Liveness Detection

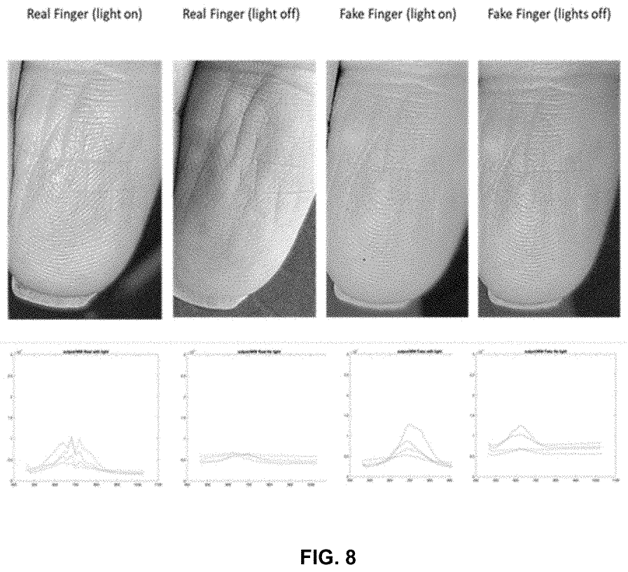

The approach for liveness detection compares images of two sets of fingers—one with the torch on and the other with the torch off. In performing this comparison, liveness is detected by monitoring the specular torch reflection in the images. FIG. 8 shows a series of images comparing a set of fingers and photographs taken both with the torch on and the torch off In FIG. 8, the leftmost image represents live finger with smartphone on during capture of picture. Second from left shows live finger with torch off. Third from left shows photograph of finger with torch on and rightmost image shows photograph of finger with light off. Charts along bottom show detection of “specular” reflection in ridges for each picture. The real images show a drop off in specular reflection with the light on and off whereas the photographs show consistency in the two images regardless whether the light is present or not.

The charts below each image in FIG. 8 represent the absolute value of the Laplacian kernel for each burst in the image. These Laplacian values rise when there are areas of sharp contrast of fingers surrounded by specular reflection and drop when this reflection is not present. For example, with the torch on, the real and fake fingers both show a peaking of Laplace values as the images becomes sharper. However, when the torch is off, the real finger pretty much flatlines while the fake still shows significant contrast. This pattern holds across all the sample data.

Afterburner Support for Latent Fingerprint Matching

All large legacy fingerprint databases use minutiae-based indexing for one-to-many matches and introducing a new fingerprint matching method would require complete re-indexing of these databases. However, for one-to-one matching, also called verification, the opportunity exists to employ new methods that do not require minutiae or hybrid methods that combine minutiae with other features such as ridge flow.

As touchless fingerprinting grows in popularity, the challenge arises in comparing touchless prints against legacy prints obtained by contact scanning. Contact and touchless prints differ in terms of geometry: contract prints are obtained by pressing and rolling a finger against a sensor while touchless prints are photographs from a camera that does not touch the finger. This difference creates resultant images displaying different geometry.

An orthogonal fingerprint matcher exists, as described in the '815 patent, in the form of the Ridge-Specific Marker (“RSM”) Algorithm, which is a graph-based method for capturing curve detail and relationships to describe objects that can be articulated as line forms. The RSM method can be applied to the comparison between any two fingerprints and offers special capabilities in comparing touchless prints to references obtained by contact methods. In this context, the term “touchless” is used to describe a captured as a photograph of a finger and developed into a high contrast fingerprint image afterwards. In the context of the smartphone-based scanner the touchless-to-reference model is the appropriate one to consider.

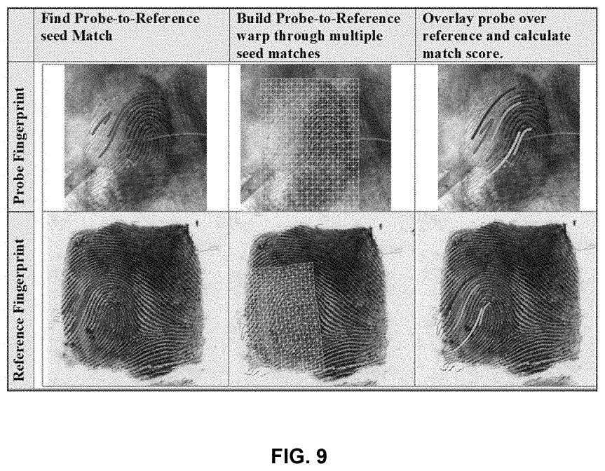

The RSM method can map touchless prints into corresponding reference prints by matching the corresponding curvatures and locations within the friction ridges across prints. FIG. 9 shows an overview of the RSM matching process when applied to latent fingerprint matching. The top row in this figure illustrates the latent print and the bottom row shows the corresponding relationship within the reference print. The first column illustrates the construction of “seeds” in the form of Bezier curves that match in latent and reference space. The second column illustrates the creation of the “warp” which captures the transformation of ridge structure from latent space to reference space due to the elasticity of skin. The third column shows the result, which is a direct mapping of the latent into reference space.

This identical method can be applied to touchless-to-reference matching. This recognition method deploys a unique method that establishes how well one fingerprint will overlay over another. The overlay is combined with a score that provides a quantitative assessment of the fit between prints with the objective of determining whether two fingerprints came from the same finger.

The RSM matching method is very powerful because it can work with very little information and does not rely on the presence of minutiae to make a match. Because the RSM method uses the wealth of feature information available through ridge structures, it can match very small physical areas of fingerprints.

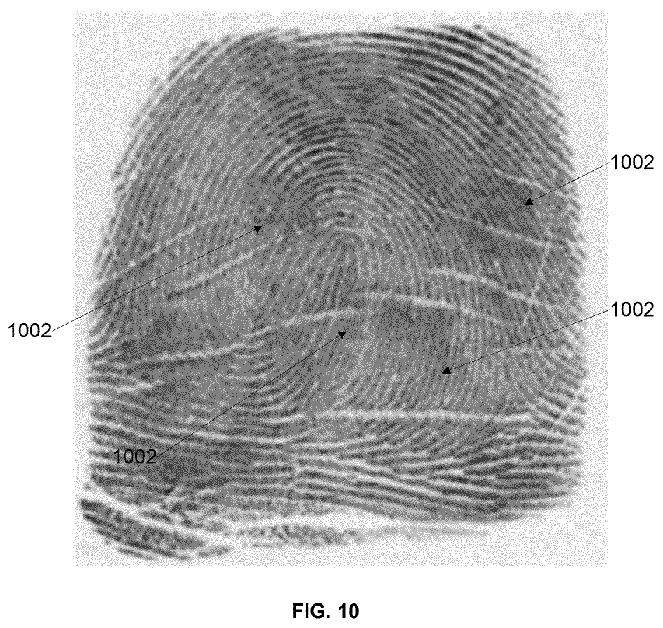

FIG. 10 shows a scale image and enlargement of several small finger fragments from the same finger matched using the RSM method—the full latent as well as extracted fragments 1002 used to accurately match the reference. As can be seen, the fragments 1002 measured 6 mm by 6 mm which is comparable to the design requirements for a reduced footprint scanner. As the fragments become this small, to improve overall accuracy, additional features can be incorporated within the RSM method to improve overall accuracy.

The above cited capabilities make the RSM method ideal for improving performance during the matching of touchless fingerprints. This improvement takes the form of employing the RSM method as an “afterburner” applied to recognition results produced by a traditional minutiae-based matcher.

FIG. 5A shows an example of four images captured by a touchless fingerprinting device in a single shot. As can be seen in this picture, the quality of the images varies with the best being the finger most directly in front of the camera lens and the worst being the one most afar from the lens—usually, the little finger. Numerous factors cause this difference in image quality including focus, occlusion, angle from lens, etc.

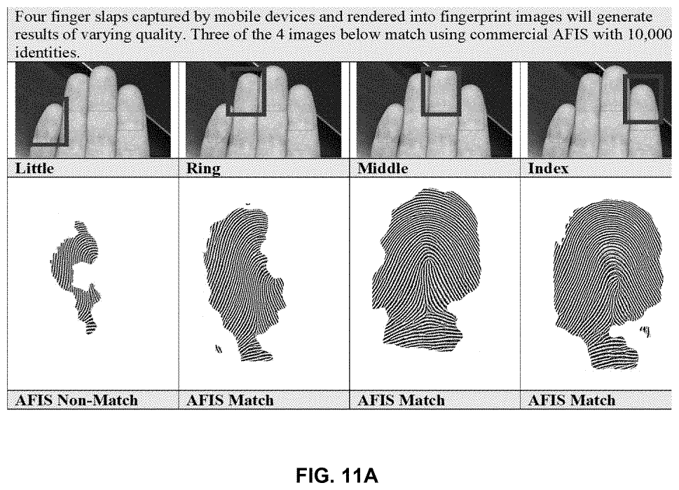

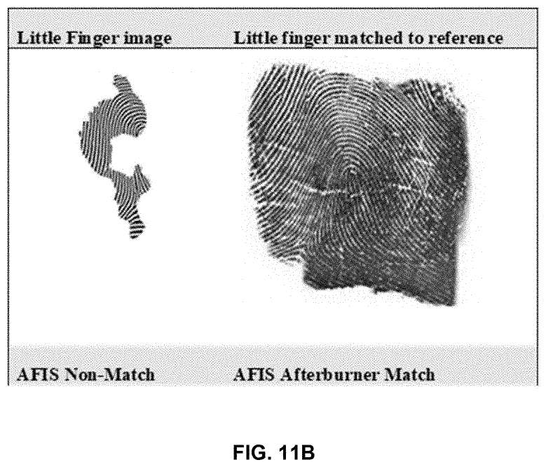

In FIG. 11A, all fingers except the little finger can be matched using a minutiae-based fingerprint matcher. The little finger exhibits too little information for minutiae matching, however, the RSM method offers a way toward recognition. FIG. 11B shows the image of the little finger from FIG. 5A successfully matched against its correct reference using the RSM method.

Because it works with small amounts of information, the RSM method can match the finger the minutiae matcher could not match. Combining RSM with traditional minutiae-based matching enables matching to be accomplished using four out of four fingers.

Orthogonal Method to as a Naked Finger Matching Method and Means of Automatic Calibration

The RSM-base fingerprint matcher can be used to support touchless fingerprinting in two additional ways: (1) processing “naked” fingers captured by the native camera application on a mobile phone (without a fingerprint capture app) and (2) automatic resizing of touchless image to match reference print (eliminating the need for calibration). These two methods are discussed in the ensuing paragraphs.

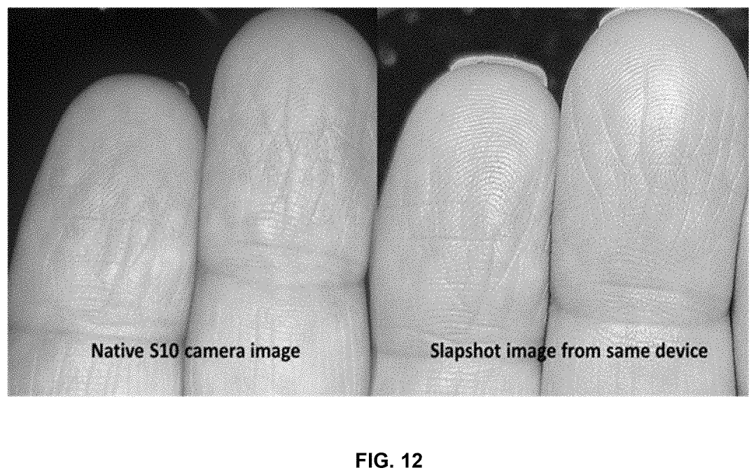

FIG. 12 shows the difference in the amount of ridge structure that can be captured using a native camera app as opposed to using an app designed expressly to capture fingerprints. The images shown on the left-side of FIG. 12 are not suitable for submission to an AFIS because of low quality. However, they are perfectly suitable for matching with the RSM-matching method. To enable these prints to be matched against a large a reference collection as possible, the AFIS Afterburner method can be used.

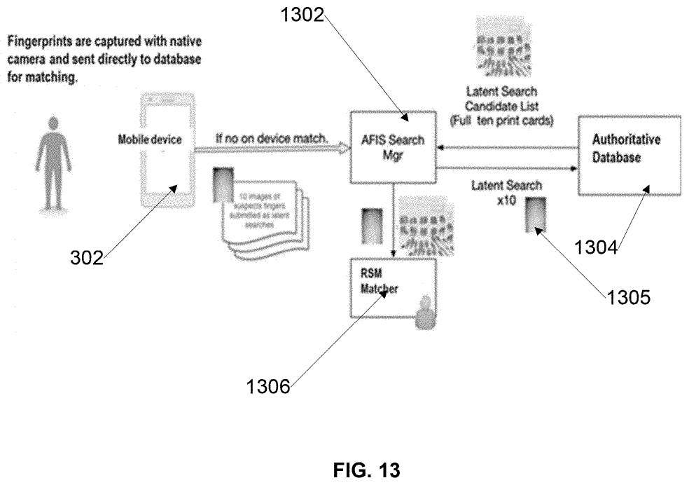

FIG. 13 describes the “afterburner” process applied to latent prints. The afterburner process entails processing contactless fingerprints from a suspect as “latents”. Prints are captured using either a dedicated app 132 or the native app on the mobile device 302, which can be user system 130. The images of the captured fingers are sent to the AFIS Search Manager 1302, which can be an external system 140 and which develops a latent print query that is submitted to the authoritative AFIS database 1304 (such as the FBI's NGI), which can also be an external system 140. The AFIS search returns a set of tenprints 1305 for candidates. These tenprints are processed by the RSM-matcher 1306, which can be part of platform 110 and which can produce a match for the suspect based on several fingers.

Similarly, images can be submitted either from a mobile fingerprinting app 132 or the native camera and the RSM matcher 1306 can be used for verification purposes. Verification is distinctive from one-to-many matching in that the identity of an individual is known and the purpose of the fingerprint comparison is to validate that the identity matches the name. Since the RSM method is “agnostic” to the scale of the actual image, it can be used to establish the scale of the touchless print by comparing it to the reference print expected to match.

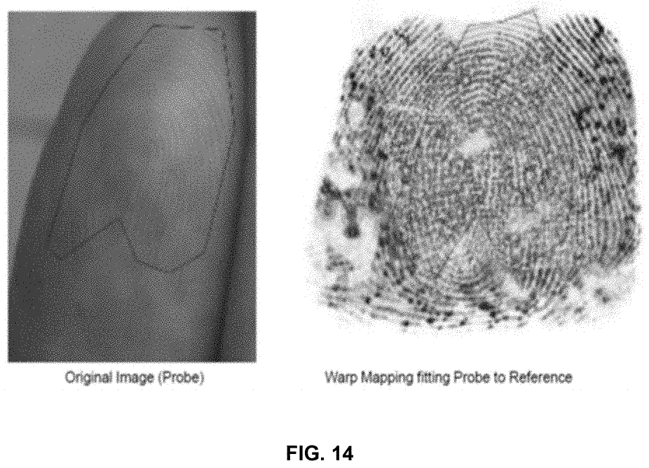

FIG. 14 shows an image of a finger mapped to the correct reference using the non-linear mesh that is intrinsic to the RSM-matching method. Since the scale of the reference is known, this mapping allows the transference of geometric measurements to the probe image bringing the probe to the same scale as the reference. This method only works for verification where the identity of the reference is known and it is being compared to the probe to confirm the identity.

True Form Rendering

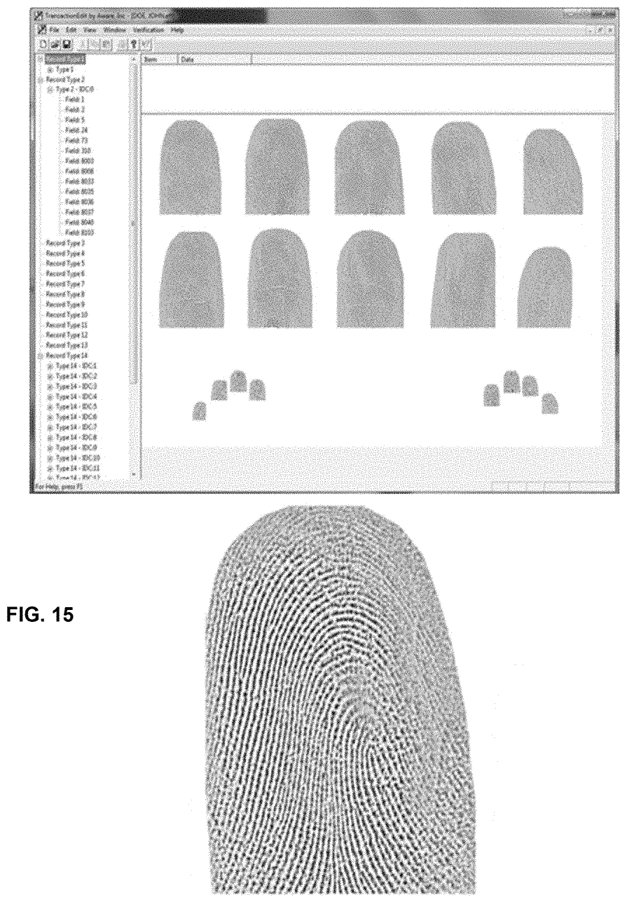

True Form Rendering is a method for rendering a touchless fingerprint image to resemble an image captured through contact fingerprinting. This method uses the high contrast generation based on localized pixel direction patterns previously disclosed in the '815 patent and applies filtering by a collection of wavelets of different size, orientation, and frequency, and a composite image is made according to the best match. FIG. 15 provides an example of a set of ten fingerprints rendered by the True Form method. In addition to rendering as much ridge structure as is visible in the original image, the True Form method also inserts segments from the original image to fill those areas that contain insufficient data to extract ridge patterns.

The above description of the disclosed embodiments is provided to enable any person skilled in the art to make or use the invention. Various modifications to these embodiments will be readily apparent to those skilled in the art, and the general principles described herein can be applied to other embodiments without departing from the spirit or scope of the invention. Thus, it is to be understood that the description and drawings presented herein represent a presently preferred embodiment of the invention and are therefore representative of the subject matter which is broadly contemplated by the present invention. It is further understood that the scope of the present invention fully encompasses other embodiments that may become obvious to those skilled in the art and that the scope of the present invention is accordingly not limited.

Combinations, described herein, such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, and any such combination may contain one or more members of its constituents A, B, and/or C. For example, a combination of A and B may comprise one A and multiple B's, multiple A's and one B, or multiple A's and multiple B's.

What is claimed:

1. A method comprising using at least one hardware processor to:
control a camera to begin at a prescribed starting position and move incrementally to capture a series of images of at least one fingerprint;
once the images are captured, evaluating the captured images for best focus using an algorithm designed expressly for fingerprint ridge structure, wherein the focus in each frame can be determined by taking the average per pixel convolution value of a Laplace filter over a small region of the full resolution image and wherein the Laplace filter comprises:
capturing an image at an initial focus distance,
convolving the captured image with Laplacian of Gaussian kernel,
assigning a score to the filtered image reflecting the amount to fine edge resolution, and
dynamically updating the focus until an optimal distance is found.
